(19) United States
(12) Patent Application Publication
(10) Pub. No.: US 2026/0311442 A1
(43) Pub. Date: Oct. 8, 2026

(54) MEDIA CONTENT PROCESSING METHOD, APPARATUS, DEVICE, MEDIUM, AND PROGRAM PRODUCT

(71) Applicant: Beijing Zitiao Network Technology Co., Ltd., Beijing (CN)

(72) Inventor: Wanyi Zhou, Beijing (CN)

(21) Appl. No.: 19/639,100

(22) Filed: Apr. 3, 2026

(30) Foreign Application Priority Data
Apr. 7, 2025 (CN) 202510428996.4

(51) Int. Cl. G06T 19/20; G06T 13/20; G06T 15/50; G11B 27/031

(52) U.S. Cl. CPC G06T 19/20; G06T 13/20; G06T 15/50; G11B 27/031; G06T 2200/24; G06T 2219/2016

(57) ABSTRACT

Embodiments of the present disclosure provide a media content processing method and apparatus, a device, a medium, and a program product. The method includes: displaying first media content and a candidate effect material set in an editing page, where the first media content includes an object; and determining a first effect material in response to a trigger operation for the candidate effect material set, determining a second effect material based on the first effect material and the object, determining second media content based on the second effect material and the first media content, and displaying the second media content, where the second media content is an effect video including an interaction relationship between the second effect material and the object.

### CROSS-REFERENCE TO RELATED APPLICATIONS

This application claims priority to Chinese Application No. 202510428996.4 filed on Apr.7, 2025, the disclosure of which is incorporated herein by reference in its entirety.

### FIELD

Embodiments of the present disclosure relate to computer technologies, and in particular, to a media content processing method and apparatus, a device, a medium, and a program product.

### BACKGROUND

At present, more and more users use applications with an image processing function to perform effect processing on pictures or videos to present different effect results. For example, a user may add an effect material to a picture or a video through an application with an image processing function, so as to enhance the expressiveness of the picture or the video and improve the visual experience of the user. However, in the media content processing manner in the related art, the effect results supported by the application are relatively limited, which affects the display effect of the media content.

### SUMMARY

Embodiments of the present disclosure provide a media content processing method and apparatus, a device, a medium, and a program product, which may optimize media content processing solutions and improve the richness of effect results.

In a first aspect, an embodiment of the present disclosure provides a media content processing method, including:

displaying first media content and a candidate effect material set in an editing page, where the first media content includes an object; and

determining a first effect material in response to a trigger operation for the candidate effect material set, determining a second effect material based on the first effect material and the object, determining second media content based on the second effect material and the first media content, and displaying the second media content, where the second media content is an effect video including an interaction relationship between the second effect material and the object.

In a second aspect, an embodiment of the present disclosure further provides a media content processing apparatus. The apparatus includes:

a displaying module, configured to display first media content and a candidate effect material set in an editing page, where the first media content includes an object; and

a content determination module, configured to determine a first effect material in response to a trigger operation for the candidate effect material set, determine a second effect material based on the first effect material and the object, determine second media content based on the second effect material and the first media content, and display the second media content, where the second media content is an effect video including an interaction relationship between the second effect material and the object.

In a third aspect, an embodiment of the present disclosure further provides an electronic device. The electronic device includes:

one or more processors; and

a storage apparatus, configured to store one or more programs which, when executed by the one or more processors, cause the one or more processors to implement the media content processing method according to any embodiment of the present disclosure.

In a fourth aspect, an embodiment of the present disclosure further provides a storage medium including computer-executable instructions. The computer-executable instructions, when executed by a computer processor, are configured to perform the media content processing method according to any embodiment of the present disclosure.

In a fifth aspect, an embodiment of the present disclosure further provides a computer program product, including computer programs. The computer programs, when executed by a processor, implement the media content processing method according to any embodiment of the present disclosure.

### BRIEF DESCRIPTION OF THE DRAWINGS

The foregoing and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic flowchart of a media content processing method according to an embodiment of the present disclosure;

FIG. 2 is a schematic diagram of second media content according to an embodiment of the present disclosure;

FIG. 3 is a schematic flowchart of another media content processing method according to an embodiment of the present disclosure;

FIG. 4 is a schematic diagram of an editing page according to an embodiment of the present disclosure;

FIG. 5 is a schematic diagram of a structure of a media content processing apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only used for exemplary purposes and are not used to limit the protection scope of the present disclosure.

It should be understood that the various steps described in the method implementations of the present disclosure may be performed in different orders and/or in parallel. In addition, the method implementations may include additional steps and/or omit the steps shown. The scope of the present disclosure is not limited in this regard.

The term "include/comprise" and its variants used herein are open-ended inclusions, that is, "include/comprise but not limited to". The term "based on" is "at least partially based on". The term "an embodiment" means "at least one embodiment"; the term "another embodiment" means "at least one another embodiment"; and the term "some embodiments" means "at least some embodiments". Related definitions of other terms will be given in the following description.

It should be noted that the concepts such as "first" and "second" mentioned in the present disclosure are only used to distinguish different apparatuses, modules, or units, and are not used to limit the order or interdependence of the functions performed by these apparatuses, modules, or units.

It should be noted that the modifications of "one" and "multiple" mentioned in the present disclosure are illustrative rather than restrictive. Those skilled in the art should understand that unless otherwise explicitly specified in the context, they should be understood as "one or multiple".

The names of messages or information exchanged between multiple apparatuses in the implementations of the present disclosure are only used for illustrative purposes, and are not used to limit the scope of these messages or information.

It may be understood that before using the technical solutions disclosed in the embodiments of the present disclosure, the user should be informed of the type, range of use, use scenarios, etc. of personal information involved in the present disclosure in an appropriate manner and the authorization of the user should be obtained in accordance with relevant laws and regulations.

For example, in response to receiving an active request from a user, prompt information is sent to the user to clearly prompt the user that the requested operation will require access to and use of the user's personal information. In this way, the user may independently choose whether to provide the personal information to software or hardware, such as an electronic device, an application, a server, or a storage medium, that performs the operations of the technical solutions of the present disclosure based on the prompt information.

As an optional but non-limiting implementation, in response to receiving an active request from a user, the prompt information may be sent to the user in the form of, for example, a pop-up window, and the prompt information may be presented in the pop-up window in text. In addition, the pop-up window may also include a selection control for the user to choose whether to "agree" or "disagree" to provide the personal information to the electronic device.

It may be understood that the above process of notifying and obtaining user authorization is only illustrative and does not constitute a limitation on the implementations of the present disclosure. Other manners that satisfy relevant laws and regulations may also be applied to the implementations of the present disclosure.

It may be understood that the data involved in the technical solution (including but not limited to the data itself, acquisition or use of the data) should comply with requirements of corresponding laws, regulations, and related provisions.

FIG. 1 is a schematic flowchart of a media content processing method according to an embodiment of the present disclosure. The embodiment of the present disclosure is applicable to a case of adding an effect to media content. The method may be performed by a media content processing apparatus. The apparatus may be implemented in the form of software and/or hardware. Optionally, the apparatus is implemented by an electronic device. The electronic device may be a mobile terminal, a PC, a server, or the like.

As shown in FIG. 1, the method includes the following steps.

At S110, first media content and a candidate effect material set are displayed in an editing page.

The first media content includes an object. The object is a main object or a foreground object in the first media content. For example, the object may include a person, an item, an animal, a plant, a building, or the like. The media content may include a picture, a video, or the like. The editing page may be an image editing page in an application with an image processing function. The candidate effect material set may be a set of candidate effect materials. The candidate effect materials may be 3D effect materials created in advance by effect generation software. A 3D model and animation of a candidate effect material may be created in advance by the effect generation software, and may be exported as an effect material package based on a preset file format. The effect material package further includes configuration information of the candidate effect material. The configuration information includes at least one of a position of a first region, a correspondence between the first region and a local region of the object, lighting information, material information, a camera position, or a model size. The camera position represents a position of a virtual camera used for rendering the candidate effect material. The animation of the candidate effect material includes animation of the 3D model rotating based on a rotation trajectory. During the rotation of the 3D model, an angle of the virtual camera is associated with a position parameter of the candidate effect material, so that the 3D model presents an effect of flipping while rotating. The rotation may be revolution around a preset surrounding point. The flipping may be rotation of the 3D model to present different side surfaces, a top surface or a bottom surface of the 3D model, thereby enhancing the stereoscopic effect of the effect material. A size of the candidate effect material is controlled by a camera angle of view. The camera angle of view is changed to control a visual distance, thereby controlling the size of the candidate effect material.

The effect material package corresponding to the candidate effect material is configured in the application with the image processing function, so that the candidate effect material may be displayed in the editing page of the application.

In response to an import event in the editing page, a media resource library is displayed. For example, the media resource library includes a local album, a cloud album, or the like. The media resource library includes candidate media content. In response to a trigger operation for the media resource library, triggered candidate media content is used as the first media content, and the first media content and an editing item are displayed in the editing page. The editing item represents an image processing option in the application with the image processing function. For example, the editing item includes an effect label, a sticker label, a template label, or the like. In response to a trigger operation for the effect label, the first media content and the candidate effect material set are displayed in the editing page. By sliding the candidate effect materials displayed in the editing page, the candidate effect material currently being displayed may be switched.

At S120, a first effect material is determined in response to a trigger operation for the candidate effect material set, a second effect material is determined based on the first effect material and the object, second media content is determined based on the second effect material and the first media content, and the second media content is displayed.

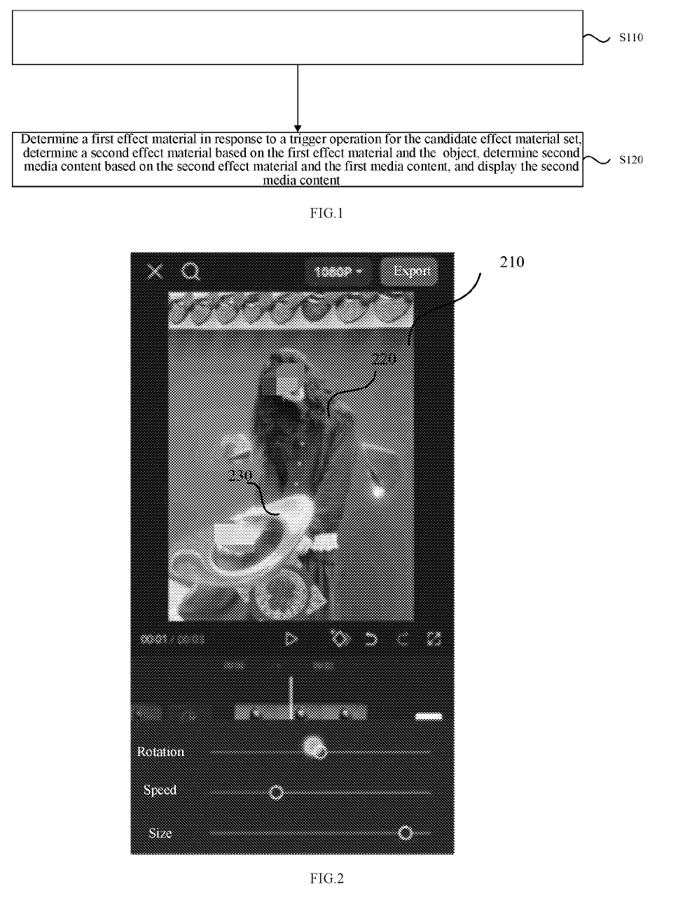

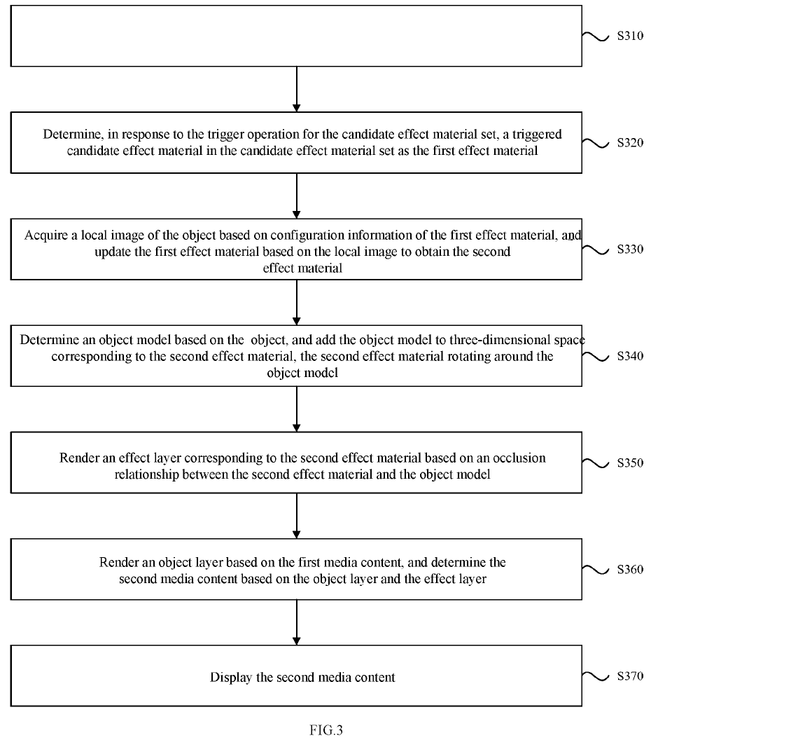

The second media content is an effect video including an interaction relationship between the second effect material and the object. The interaction relationship includes an interaction relationship between the second effect material and the object, and/or a content interaction relationship between the second effect material and the object, and the like. For example, the interaction relationship may include displaying content of the object on a surface of the second effect material. The interaction relationship may further include the candidate effect material rotating around the object, or the candidate effect material being emitted by the object, or the candidate effect material passing in front of the object, and the like. Animation corresponding to the interaction relationship may be created by the effect generation software. For example, the second media content may be an effect video in which the second effect material rotates around the object. FIG. 2 is a schematic diagram of second media content according to an embodiment of the present disclosure. As shown in FIG. 2, a second effect material 230 surrounds an object 220 in second media content 210. A first region 240 of the second effect material 230 includes a local image of the object 220. In some embodiments, the second effect material 230 includes three ingot effects. In some other embodiments, the second effect material 230 may further be a heart-shaped effect or other effect materials. The three ingot effects in FIG. 2 rotate around the object and also rotate based on respective rotation axes.

Optionally, the second effect material is applied to the first media content based on an occlusion relationship between the object and the second effect material, to obtain the second media content. The first effect material represents a candidate effect material selected from the candidate effect material set. The first effect material may be selected from the candidate effect material set through a trigger operation for the candidate effect materials in the candidate effect material set. The trigger operation includes a click operation, a selection operation, a long press operation, a gaze operation, a voice indication, or the like. Optionally, the first effect material includes a first region and a second region. Material information of the first region is the same as that of the second region. The first region is used for displaying a local image of the object. The second effect material represents an effect material with the local image of the object.

Exemplarily, in response to the trigger operation for the candidate effect material set, a triggered candidate effect material in the candidate effect material set is determined as the first effect material. A local image of the object is acquired based on configuration information of the first effect material, and the first effect material is updated based on the local image to obtain the second effect material.

For example, in response to a trigger operation for a candidate effect material in the candidate effect material set, the triggered candidate effect material is used as the first effect material. Based on the configuration information corresponding to the first effect material, a position of the first region of the first effect material and an object region of the object corresponding to the first region are determined. Assuming that the object region corresponding to the first region of the first effect material is an object head, the object head in the first media content may be identified by an image identification algorithm. The local image corresponding to the object head in the first media content is acquired by an image segmentation algorithm. Alternatively, assuming that the object region corresponding to the first region of the first effect material is an upper half of the object, the upper half of the object in the first media content may be identified by the image identification algorithm. The local image corresponding to the upper half of the object in the first media content is acquired by the image segmentation algorithm. The first region in the first effect material is updated based on a position and color of a pixel in the local image to obtain the second effect material. Alternatively, assuming that the object region corresponding to the first region of the first effect material is the entire object, an object image of the object in the first media content may be acquired by the image segmentation algorithm. Optionally, in response to the first media content including a plurality of main objects and the object being one of the main objects, the object in the first media content is identified based on the image identification algorithm. Then, the object image of the object in the first media content is acquired by the image segmentation algorithm. The first region in the first effect material is updated based on a position and color of a pixel in the object image to obtain the second effect material.

Optionally, there may be at least one first region. In response to there being one first region, a color parameter in a material parameter of the first region is updated based on the position and color of the pixel in the local image, so as to update the first effect material based on the local image. In response to there being two or more first regions, color parameters in material parameters of different first regions are updated based on a position and color of the local image. Optionally, for different first regions, different texture mapping strategies may be adopted to display local images in different directions in the different first regions.

Optionally, a first map corresponding to the first region and a second map corresponding to the second region are determined based on the configuration information of the first effect material. The position of the first region in the first effect material is determined based on a position of the first map in the first effect material. The local image is acquired from the first media content based on the object region. The first region in the first effect material is updated based on the position and color of the pixel in the local image to obtain the second effect material.

In some embodiments, the first region in the first effect material is a plane, and based on a mapping relationship between the first region and texture coordinates of the local image, a color of a corresponding position in the first region is updated with a color of a pixel corresponding to each texture coordinate in the local image, so as to update the first effect material.

In the embodiments of the present disclosure, the first effect material is updated based on the local image of the object, so that the first effect material has image content of the object in the first media content, a close connection between the media content and the effect material is established, and the interest of the effect material is increased.

Exemplarily, updating the first effect material based on the local image to obtain the second effect material includes:

determining a first region in the first effect material based on the configuration information, and unfolding the first region into a plane region; mapping the local image to the plane region based on a texture coordinate correspondence between the local image and the plane region to obtain a plane image; and determining the second effect material based on the plane image and the first effect material.

The texture coordinate correspondence includes a texture distribution relationship. For example, the texture coordinate correspondence includes: a pixel point at texture coordinates (0, 0) of the local image being mapped to a vertex at a lower left corner of the plane region, a pixel point at texture coordinates (1, 1) of the local image being mapped to a vertex at an upper right corner of the plane region, and pixel points at other texture coordinates in the local image being mapped to an interior of the plane region.

In response to the first region in the first effect material being not a plane, the first region is first unfolded, and the first region is unfolded into a plane region. For example, each model vertex in the first effect material corresponds to a UV coordinate point, and the first region is unfolded into the plane region by UV unfolding, so as to convert the first region from a three-dimensional curved surface to a two-dimensional plane. The UV coordinate point represents a point in a two-dimensional texture coordinate system. Through the UV unfolding, the three-dimensional surface of the first effect material is converted into the two-dimensional plane, which facilitates determination of image content of the plane region based on the local image, and improves image mapping efficiency.

Optionally, determining the second effect material based on the plane image and the first effect material includes:

mapping the plane image back to the first region of the first effect material to obtain the second effect material.

For example, a value range of an abscissa and a value range of an ordinate of a UV coordinate point of the local image are between 0 and 1. UV coordinates of a lower left corner of the local image are (0, 0), and UV coordinates of an upper right corner of the local image are (1, 1). A pixel at the point (0, 0) in the lower left corner of the local image is mapped to a vertex at a lower left corner of the plane region, a pixel at the point (1, 1) in the upper right corner of the local image is mapped to a vertex at an upper right corner of the plane region, and pixels at other UV coordinates in the local image are mapped to an interior of the plane region to obtain the plane image. Based on a correspondence between the plane region and the first region, the plane image is used as a map of the first region in the first effect material and pasted back to the first region of the first effect material to obtain the second effect material. In the embodiments of the present disclosure, based on the texture coordinates of the local image, the pixels of the local image are mapped to the plane region to obtain the plane image, and then the plane image is mapped to the surface of the three-dimensional model, so that the local image of the object is displayed on the local surface of the second effect material, and the effect results are enriched.

Exemplarily, the second effect material is applied to the first media content based on an occlusion relationship between the object and the second effect material to obtain the second media content, and the second media content is displayed. For example, an effect material adding position may be determined based on the configuration information, and the occlusion relationship between the object and the second effect material is determined based on the effect material adding position. The second effect material is applied to the first media content based on the occlusion relationship between the object and the second effect material to obtain the second media content.

Optionally, in response to a position adjustment operation for the second effect material in the second media content, the second effect material in the second media content is adjusted to move upward or downward. In the embodiments of the present disclosure, the second effect material is moved upward or downward, so that the effect result presented by the second media content meets an expectation.

In the technical solutions of the embodiments of the present disclosure, the first media content and the candidate effect material set are displayed in the editing page, the first effect material is determined in response to the trigger operation for the candidate effect material set, the second effect material is determined based on the first effect material and the object, and the second media content is determined based on the second effect material and the first media content. In the embodiments of the present disclosure, the second effect material is determined based on the first effect material and the object, and then the second effect material is applied to the first media content, to enable to display the object in the second effect material and display the effect material in the second media content, thereby achieving the effect of content interaction between the media content and the effect material, solving the problem of the limited effect material, and improving the richness of the effect results. The second effect material is applied to the first media content to obtain the second media content with rich images, thereby optimizing the display effect of the media content.

FIG. 3 is a schematic flowchart of another media content processing method according to an embodiment of the present disclosure. On the basis of the above embodiments, the embodiment of the present disclosure specifically defines a generation manner of second media content. As shown in FIG. 3, the method includes the following steps.

At S310, first media content and a candidate effect material set are displayed in an editing page.

The first media content includes an object.

At S320, in response to a trigger operation for the candidate effect material set, a triggered candidate effect material in the candidate effect material set is determined as a first effect material.

At S330, a local image of the object is acquired based on configuration information of the first effect material, and the first effect material is updated based on the local image to obtain a second effect material.

Exemplarily, a first region in the first effect material is determined based on the configuration information, and the first region is unfolded into a plane region. The local image is mapped to the plane region based on a texture coordinate correspondence between the local image and the plane region to obtain a plane image. The second effect material is determined based on the plane image and the first effect material. Optionally, the plane image is mapped back to the first region of the first effect material to obtain the second effect material.

Alternatively, the first region in the first effect material is determined based on the configuration information, and the local image of the object is projected to the first region in the first effect material through texture coordinates to obtain the second effect material.

At S340, an object model is determined based on the object, and the object model is added to three-dimensional space corresponding to the second effect material. The second effect material rotates around the object model.

The object model may be a three-dimensional model of the object. Optionally, the object model may be the object represented by a three-dimensional network. For example, a segmentation result of the object in the first media content is acquired by an image segmentation algorithm. The object model of the object is generated based on the segmentation result of the object. An effect material adding position is determined based on the configuration information, and the object model of the object is added to the three-dimensional space corresponding to the second effect material based on the adding position, so as to achieve an occlusion effect of the second effect material. For example, in response to the effect material adding position being a head of the object, the object model may be added to the three-dimensional space corresponding to the second effect material based on the adding position, so as to achieve the occlusion effect between the object model and the second effect material.

For example, for the effect material that moves around the object, the configuration information includes configuration information such as a surrounding trajectory and a surrounding point. The effect material surrounding the object is only an example of an interaction manner between the effect material and the object, and the candidate effect materials in the candidate effect material set may further include other interaction manners.

The surrounding point may represent a rotation center of the second effect material rotating along the surrounding trajectory. Optionally, the object model corresponding to the object is added to the three-dimensional space corresponding to the second effect material, and the surrounding point is located on a vertical symmetry axis of the object model, thereby ensuring that the object model is located in a center of the second effect material, and the second effect material rotates around the object model.

At S350, an effect layer corresponding to the second effect material is rendered based on an occlusion relationship between the second effect material and the object model.

The effect layer is a layer used for rendering the second effect material.

Exemplarily, visibility of the second effect material is adjusted based on the occlusion relationship between the second effect material and the object model. For example, in response to the second effect material rotating to a back side of the object model, the second effect material is completely occluded by the object model, and the second effect material completely occluded by the object model is not displayed. In response to a part of the region of the second effect material being located behind the object model, the second effect material is partially occluded by the object model, and the region in the second effect material that is occluded by the object model is not displayed. In response to the second effect material rotating to a front side of the object model, the complete second effect material is displayed, and a local region of the object model is occluded by the second effect material.

Optionally, rendering the effect layer corresponding to the second effect material based on the occlusion relationship between the second effect material and the object model includes: determining lighting information and material information of the second effect material based on the configuration information; and rendering the effect layer corresponding to the second effect material based on the occlusion relationship, the lighting information and the material information. The effect material is rendered by combining the lighting information and the material information, so that the effect material may present light and shadow and material effects. By adjusting the lighting information and the material information, the light and shadow and material effects of the image in the effect layer are adjusted, and the effect result is enhanced.

At S360, an object layer is rendered based on the first media content, and the second media content is determined based on the object layer and the effect layer.

The object layer is a layer used for rendering the first media content. The second media content is determined based on the object layer and the effect layer.

At S370, the second media content is displayed.

Exemplarily, an editing control set and the second media content are displayed in the editing page, where an editing control in the editing control set includes at least one of a rotation control, a speed adjustment control or a size adjustment control. In response to a trigger operation for the editing control, an attribute of the second effect material in the second media content is updated, where the attribute includes at least one of a pose, a speed or a size.

The second media content includes the object layer and the effect layer, and the second effect material in the effect layer may be edited by the editing control to adjust the effect result of the second media content.

For example, a rotation angle and a camera position corresponding to the second effect material are determined in response to a trigger operation for the rotation control, and the pose of the second effect material in the second media content is updated based on the rotation angle and the camera position. The rotation angle may be an inclination angle of the second effect material. The camera position update includes adjusting a position of the camera relative to the second effect material.

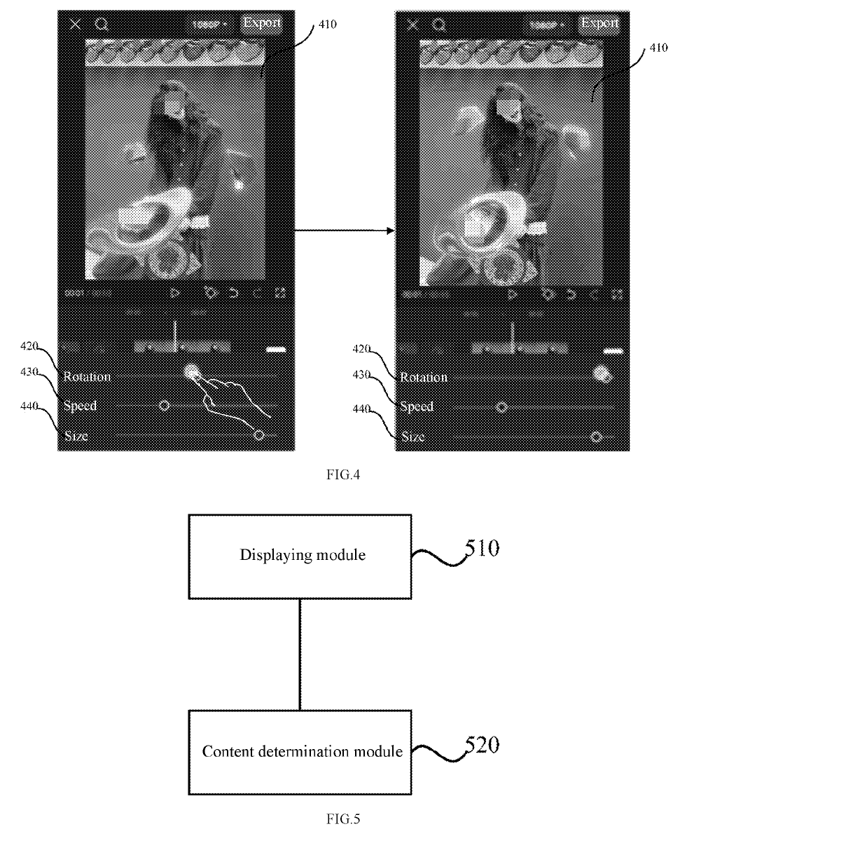

FIG. 4 is a schematic diagram of an editing page according to an embodiment of the present disclosure. As shown in FIG. 4, a rotation control 420, a speed adjustment control 430, and a size adjustment control 440 are displayed in an editing page 410. In response to a trigger operation for the rotation control 420, a rotation angle and a camera position corresponding to the second effect material are determined based on the trigger operation. The pose of the second effect material is updated based on the rotation angle and the camera position, and the adjusted second media content is displayed in the editing page 410.

Optionally, in response to an export operation for the second media content in the editing page, the effect layer and the object layer are merged to export an effect video of the object.

In the technical solutions of the embodiments of the present disclosure, the object is segmented from the first media content, the three-dimensional object model is generated based on the object, the object model is added to the three-dimensional space corresponding to the second effect material, and the effect layer corresponding to the second effect material is rendered based on the occlusion relationship between the second effect material and the object model. The object layer is rendered based on the first media content, and the second media content is determined based on the object layer and the effect layer, so that the second media content presents a real spatial occlusion effect, and a situation that the second effect material floats above the object and affects the image effect of the second media content is avoided, thereby improving the image quality of the second media content.

FIG. 5 is a schematic diagram of a structure of a media content processing apparatus according to an embodiment of the present disclosure. The apparatus may be implemented in a form of software and/or hardware, and optionally, by an electronic device. The electronic device may be a mobile terminal, a PC, a server, or the like.

As shown in FIG. 5, the apparatus includes: a displaying module 510 and a content determination module 520.

The displaying module 510 is configured to display first media content and a candidate effect material set in an editing page, where the first media content includes an object.

The content determination module 520 is configured to determine a first effect material in response to a trigger operation for the candidate effect material set, determine a second effect material based on the first effect material and the object, determine second media content based on the second effect material and the first media content, and display the second media content. The second media content is an effect video including an interaction relationship between the second effect material and the object.

Optionally, determining the first effect material in response to the trigger operation for the candidate effect material set, and determining the second effect material based on the first effect material and the object include:

determining, in response to the trigger operation for the candidate effect material set, a triggered candidate effect material in the candidate effect material set as the first effect material; and

acquiring a local image of the object based on configuration information of the first effect material, and updating the first effect material based on the local image to obtain the second effect material.

Optionally, updating the first effect material based on the local image to obtain the second effect material includes:

determining a first region in the first effect material based on the configuration information, and unfolding the first region into a plane region;

mapping the local image to the plane region based on a texture coordinate correspondence between the local image and the plane region to obtain a plane image; and

determining the second effect material based on the plane image and the first effect material.

Optionally, determining the second effect material based on the plane image and the first effect material includes:

mapping the plane image back to the first region of the first effect material to obtain the second effect material.

Optionally, the determining the second media content based on the second effect material and the first media content includes:

applying the second effect material to the first media content based on an occlusion relationship between the object and the second effect material to obtain the second media content.

Optionally, applying the second effect material to the first media content based on the occlusion relationship between the object and the second effect material to obtain the second media content includes:

determining an object model based on the object, and adding the object model to three-dimensional space corresponding to the second effect material, the second effect material rotating around the object model;

rendering an effect layer corresponding to the second effect material based on an occlusion relationship between the second effect material and the object model; and

rendering an object layer based on the first media content, and determining the second media content based on the object layer and the effect layer.

Optionally, rendering the effect layer corresponding to the second effect material based on the occlusion relationship between the second effect material and the object model includes:

determining lighting information and material information of the second effect material based on the configuration information; and

rendering the effect layer corresponding to the second effect material based on the occlusion relationship, the lighting information and the material information.

Optionally, displaying the second media content includes:

displaying an editing control set and the second media content in the editing page, where an editing control in the editing control set includes at least one of a rotation control, a speed adjustment control or a size adjustment control; and

updating an attribute of the second effect material in the second media content in response to a trigger operation for the editing control, where the attribute includes at least one of a pose, a speed or a size.

Optionally, updating the attribute of the second effect material in the second media content in response to the trigger operation for the editing control includes:

determining, in response to a trigger operation for the rotation control, a rotation angle and a camera position corresponding to the second effect material, and updating the pose of the second effect material in the second media content based on the rotation angle and the camera position.

The media content processing apparatus provided by an embodiment of the present disclosure may perform the media content processing method provided by any embodiment of the present disclosure, and has function modules and beneficial effects corresponding to the method performed.

It is worth noting that the units and modules included in the above apparatus are only divided based on functional logic, but are not limited to the above division, as long as the corresponding functions may be implemented. In addition, the specific names of the functional units are only for the convenience of distinguishing from each other, and are not used to limit the protection scope of the embodiments of the present disclosure.

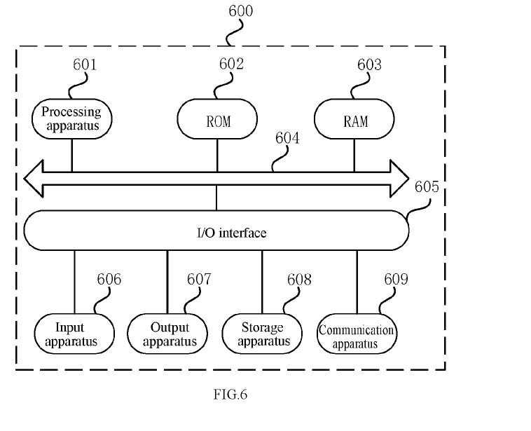

FIG. 6 is a schematic diagram of a structure of an electronic device according to an embodiment of the present disclosure. Reference is made to FIG. 6 below, which illustrates a schematic diagram of a structure of an electronic device (such as a terminal device or a server in FIG. 6) 600 suitable for implementing the embodiments of the present disclosure. The terminal device in the embodiments of the present disclosure may include, but is not limited to, mobile terminals such as a mobile phone, a notebook computer, a digital broadcast receiver, a PDA (personal digital assistant), a tablet computer (PAD), a PMP (portable multimedia player), and an in-vehicle terminal (such as an in-vehicle navigation terminal); and fixed terminals such as a digital TV and a desktop computer. The electronic device shown in FIG. 6 is only an example, and should not impose any limitation on the function and scope of use of the embodiments of the present disclosure.

As shown in FIG. 6, the electronic device 600 may include a processing apparatus (such as a central processing unit and a graphics processor) 601, which may perform various appropriate actions and processing based on programs stored in a read-only memory (ROM) 602 or programs loaded from a storage apparatus 608 into a random access memory (RAM) 603. The RAM 603 further stores various programs and data required for operations of the electronic device 600. The processing apparatus 601, the ROM 602, and the RAM 603 are connected to each other through a bus 604. An editing/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; a storage apparatus 608 including, for example, a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all the apparatuses shown. Alternatively, more or fewer apparatuses may be implemented or provided.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program codes for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the functions defined in the method of the embodiment of the present disclosure are executed.

The names of messages or information exchanged between multiple apparatuses in the implementations of the present disclosure are only used for illustrative purposes, and are not used to limit the scope of these messages or information.

The electronic device provided by an embodiment of the present disclosure belongs to the same inventive concept as the media content processing method provided by the above embodiments. For the technical details not described in detail in this embodiment, reference may be made to the above embodiments, and this embodiment has the same beneficial effects as the above embodiments.

An embodiment of the present disclosure provides a computer storage medium having computer programs stored thereon. The programs, when executed by a processor, implement the media content processing method provided by the above embodiments.

It should be noted that the computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores programs, and the programs may be used by or in combination with an instruction execution system, apparatus, or device. In the present disclosure, the computer-readable signal medium may include a data signal propagated on a baseband or as a part of a carrier, and computer-readable program code is carried in the data signal. This propagated data signal may adopt multiple forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to, a wire, an optical cable, an RF (radio frequency), or any suitable combination of the above.

In some implementations, the client and the server may communicate using any currently known or future developed network protocol, such as the HTTP (HyperText Transfer Protocol), and may be interconnected with any form or medium of digital data communication (for example, a communication network). Examples of the communication network include a local area network ("LAN"), a wide area network ("WAN"), an internet (for example, the Internet), a peer-to-peer network (for example, an ad hoc network), and any network currently known or to be developed in the future.

The computer-readable medium may be contained in the electronic device or may exist alone without being assembled into the electronic device.

The computer-readable medium carries one or more programs which, when executed by the electronic device, cause the electronic device to:

display first media content and a candidate effect material set in an editing page, where the first media content includes an object; and

determine a first effect material in response to a trigger operation for the candidate effect material set, determine a second effect material based on the first effect material and the object, determine second media content based on the second effect material and the first media content, and display the second media content, where the second media content is an effect video including an interaction relationship between the second effect material and the object.

The computer program codes for performing the operations of the present disclosure may be written in one or more programming languages or a combination thereof, where the programming languages include, but are not limited to, object-oriented programming languages such as Java, Smalltalk, and C++, and may also include conventional procedural programming languages such as "C" language or similar programming languages. The program codes may be completely executed on a user computer, partially executed on a user computer, executed as an independent software package, partially executed on a user computer and partially executed on a remote computer, or completely executed on a remote computer or server. In the case of involving a remote computer, the remote computer may be connected to the user computer through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the systems, methods and computer program products according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by software or hardware. The name of the unit does not constitute a limitation on the unit itself under certain circumstances.

The functions described above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store programs for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only a preferred embodiment of the present disclosure and an explanation of the technical principles employed. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosed concept. For example, the above features and the technical features disclosed in the present disclosure (but not limited to) with similar functions may be replaced each other to form a technical solution.

In addition, although the various operations are depicted in a particular order, this should not be understood as requiring the operations to be performed in the particular order shown or in a sequential order. Under certain circumstances, multitasking and parallel processing may be beneficial. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only exemplary forms for implementing the claims.

We claim:

1. A media content processing method, comprising:
displaying first media content and a candidate effect material set in an editing page, wherein the first media content comprises an object; and
determining a first effect material in response to a trigger operation for the candidate effect material set, determining a second effect material based on the first effect material and the object, determining second media content based on the second effect material and the first media content, and displaying the second media content, wherein the second media content is an effect video comprising an interaction relationship between the second effect material and the object.

2. The method of claim 1, wherein determining the first effect material in response to the trigger operation for the candidate effect material set, and determining the second effect material based on the first effect material and the object comprise:
determining, in response to the trigger operation for the candidate effect material set, a triggered candidate effect material in the candidate effect material set as the first effect material; and
acquiring a local image of the object based on configuration information of the first effect material, and updating the first effect material based on the local image to obtain the second effect material.

3. The method of claim 2, wherein updating the first effect material based on the local image to obtain the second effect material comprises:
determining a first region in the first effect material based on the configuration information, and unfolding the first region into a plane region;
mapping the local image to the plane region based on a texture coordinate correspondence between the local image and the plane region to obtain a plane image; and
determining the second effect material based on the plane image and the first effect material.

4. The method of claim 3, wherein determining the second effect material based on the plane image and the first effect material comprises:
mapping the plane image back to the first region of the first effect material to obtain the second effect material.

5. The method of claim 2, wherein determining the second media content based on the second effect material and the first media content comprises:
applying the second effect material to the first media content based on an occlusion relationship between the object and the second effect material to obtain the second media content.

6. The method of claim 5, wherein applying the second effect material to the first media content based on the occlusion relationship between the object and the second effect material to obtain the second media content comprises:
determining an object model based on the object, and adding the object model to three-dimensional space corresponding to the second effect material, the second effect material rotating around the object model;
rendering an effect layer corresponding to the second effect material based on an occlusion relationship between the second effect material and the object model; and
rendering an object layer based on the first media content, and determining the second media content based on the object layer and the effect layer.

7. The method of claim 6, wherein rendering the effect layer corresponding to the second effect material based on the occlusion relationship between the second effect material and the object model comprises:
determining lighting information and material information of the second effect material based on the configuration information; and
rendering the effect layer corresponding to the second effect material based on the occlusion relationship, the lighting information and the material information.

8. The method of claim 1, wherein displaying the second media content comprises:
displaying an editing control set and the second media content in the editing page, wherein an editing control in the editing control set comprises at least one of a rotation control, a speed adjustment control or a size adjustment control; and
updating an attribute of the second effect material in the second media content in response to a trigger operation for the editing control, wherein the attribute comprises at least one of a pose, a speed or a size.

9. The method of claim 8, wherein updating the attribute of the second effect material in the second media content in response to the trigger operation for the editing control comprises:
determining, in response to a trigger operation for the rotation control, a rotation angle and a camera position corresponding to the second effect material, and updating the pose of the second effect material in the second media content based on the rotation angle and the camera position.

10. An electronic device, comprising:
one or more processors; and
a storage apparatus configured to store one or more programs which, when executed by the one or more processors, configure the one or more processors to:
display first media content and a candidate effect material set in an editing page, wherein the first media content comprises an object; and
determine a first effect material in response to a trigger operation for the candidate effect material set, determine a second effect material based on the first effect material and the object, determine second media content based on the second effect material and the first media content, and display the second media content, wherein the second media content is an effect video comprising an interaction relationship between the second effect material and the object.

11. The electronic device of claim 10, wherein the one or more programs to configure the one or more processors to determine the first effect material in response to the trigger operation for the candidate effect material set, and determine the second effect material based on the first effect material and the object comprise one or more programs to configure the one or more processors to:
determine, in response to the trigger operation for the candidate effect material set, a triggered candidate effect material in the candidate effect material set as the first effect material; and
acquire a local image of the object based on configuration information of the first effect material, and update the first effect material based on the local image to obtain the second effect material.

12. The electronic device of claim 11, wherein the one or more programs to configure the one or more processors to update the first effect material based on the local image to obtain the second effect material comprise one or more programs to configure the one or more processors to:
determine a first region in the first effect material based on the configuration information, and unfold the first region into a plane region;
map the local image to the plane region based on a texture coordinate correspondence between the local image and the plane region to obtain a plane image; and
determine the second effect material based on the plane image and the first effect material.

13. The electronic device of claim 12, wherein the one or more programs to configure the one or more processors to determine the second effect material based on the plane image and the first effect material comprise one or more programs to configure the one or more processors to:
map the plane image back to the first region of the first effect material to obtain the second effect material.

14. The electronic device of claim 11, wherein the one or more programs to configure the one or more processors to determine the second media content based on the second effect material and the first media content comprise one or more programs to configure the one or more processors to:
apply the second effect material to the first media content based on an occlusion relationship between the object and the second effect material to obtain the second media content.

15. The electronic device of claim 14, wherein the one or more programs to configure the one or more processors to apply the second effect material to the first media content based on the occlusion relationship between the object and the second effect material to obtain the second media content comprise one or more programs to configure the one or more processors to:
determine an object model based on the object, and add the object model to three-dimensional space corresponding to the second effect material, the second effect material rotating around the object model;
render an effect layer corresponding to the second effect material based on an occlusion relationship between the second effect material and the object model; and
render an object layer based on the first media content, and determine the second media content based on the object layer and the effect layer.

16. The electronic device of claim 15, wherein the one or more programs to configure the one or more processors to render the effect layer corresponding to the second effect material based on the occlusion relationship between the second effect material and the object model comprise one or more programs to configure the one or more processors to:
determine lighting information and material information of the second effect material based on the configuration information; and
render the effect layer corresponding to the second effect material based on the occlusion relationship, the lighting information and the material information.

17. The electronic device of claim 10, wherein the one or more programs to configure the one or more processors to display the second media content comprise one or more programs to configure the one or more processors to:
display an editing control set and the second media content in the editing page, wherein an editing control in the editing control set comprises at least one of a rotation control, a speed adjustment control or a size adjustment control; and
update an attribute of the second effect material in the second media content in response to a trigger operation for the editing control, wherein the attribute comprises at least one of a pose, a speed or a size.

18. The electronic device of claim 17, wherein the one or more programs to configure the one or more processors to update the attribute of the second effect material in the second media content in response to the trigger operation for the editing control comprise one or more programs to configure the one or more processors to:
determine, in response to a trigger operation for the rotation control, a rotation angle and a camera position corresponding to the second effect material, and update the pose of the second effect material in the second media content based on the rotation angle and the camera position.

19. A non-transitory storage medium comprising computer-executable instructions, wherein the computer-executable instructions, when executed by a computer processor, are configured to:
display first media content and a candidate effect material set in an editing page, wherein the first media content comprises an object; and
determine a first effect material in response to a trigger operation for the candidate effect material set, determine a second effect material based on the first effect material and the object, determine second media content based on the second effect material and the first media content, and display the second media content, wherein the second media content is an effect video comprising an interaction relationship between the second effect material and the object.

20. The non-transitory storage medium of claim 19, wherein the computer-executable instructions configured to determine the first effect material in response to the trigger operation for the candidate effect material set, and determine the second effect material based on the first effect material and the object comprise computer-executable instructions configured to:
determine, in response to the trigger operation for the candidate effect material set, a triggered candidate effect material in the candidate effect material set as the first effect material; and
acquire a local image of the object based on configuration information of the first effect material, and update the first effect material based on the local image to obtain the second effect material.
